(19) United States
(12) Patent Application Publication
(10) Pub. No.: US 2016/0341075 A1
(43) Pub. Date: Nov. 24, 2016

(54) ENERGY DISSIPATING CORE CASE CONTAINMENT SECTION FOR A GAS TURBINE ENGINE

(71) Applicant: UNITED TECHNOLOGIES CORPORATION, Farmington, CT (US)

(72) Inventors: Shu Liu, South Glastonbury, CT (US); Robert Russell Mayer, Manchaester, CT (US); Paul W. Palmer, S. Glastonbury, CT (US); Peter Balawajder, Vernon, CT (US); Igor S. Garcia, Salem, CT (US); David C. Pimenta, Rocky Hill, CT (US); Stephanie Ernst, Meriden, CT (US); Fernando K. Grant, South Windsor, CT (US); Eric Baker, Vernon, CT (US); Andrew S. Miller, Marlbourgh, CT (US)

(21) Appl. No.: 15/106,615

(22) PCT Filed: Aug. 15, 2014
(86) PCT No.: PCT/US2014/051195

§ 371 Date: Jun. 20, 2016

Related U.S. Application Data
(60) Provisional application No. 61/918,202, filed on Dec. 19, 2013.

(51) Int. Cl. F01D 25/26; F23R 3/00; F04D 29/52; F02C 3/04; F02K 3/06

(52) U.S. Cl. CPC F01D 25/26; F02C 3/04; F02K 3/06; F04D 29/522; F23R 3/002; F05D 2220/32; F05D 2300/506

(57) ABSTRACT

A gas turbine engine includes a core assembly with a core case having a containment section for containing liberated compressor and turbine blades and blade fragments. The containment section includes first and second containment layers and the containment section is configured to have a non-linear rate of energy dissipation across the first and second containment layers, thereby to improve containment of blades and blade fragments.

### TECHNICAL FIELD

This disclosure generally relates to gas turbine engines, and more particularly to core cases for gas turbine engines.

### BACKGROUND

Gas turbine engines may generally include a fan section coupled to a core assembly. The core assembly may include a compressor section having one or more compressors, a combustion section, and a turbine section having one or more turbines. Each compressor includes multiple compressor blades while each turbine section includes multiple turbine blades. The compressor and turbine blades are disposed within a core case and are rotated rapidly during operation.

It is possible, although unlikely, for a compressor or turbine blade, or a fragment thereof, to separate during operation and strike the core case. Accordingly, core cases are often designed to contain blades and blade fragments, thereby to prevent any liberated material from radially exiting the engine. The demands of blade containment, however, are balanced by the demands for low weight and high strength. Adequate containment is often obtained by increasing the thickness of the core case sufficiently to resistant penetration by a blade or blade fragment. A thicker core case, however, adds weight to the core assembly, thereby reducing engine efficiency.

### SUMMARY OF THE DISCLOSURE

In accordance with one aspect of the disclosure, a gas turbine engine disposed along a longitudinal engine axis may include a fan assembly and a core assembly coupled to the fan assembly. The core assembly may include a compressor section, a turbine section, and a core case surrounding the compressor section and the turbine section. The core case may define a containment section surrounding at least one of the compressor section and the turbine section, the containment section including a first containment layer and a second containment layer, the containment section being configured to have a non-linear rate of energy dissipation across the first and second containment layers.

In accordance with one aspect of the disclosure, a core assembly may include a compressor section, a turbine section, and a core case surrounding the compressor section and the turbine section. The core case may define a containment section surrounding at least one of the compressor section and the turbine section, the containment section including a first containment layer defining a first surface and a second containment layer defining a second surface directly coupled to the first surface. The first containment layer may have a first containment layer property and the second containment layer may have a second containment layer property different from the first containment layer property so that the containment section has a non-linear rate of energy dissipation across the first and second containment layers.

In accordance with one aspect of the disclosure, a gas turbine engine disposed along a longitudinal engine axis may include a fan assembly and a core assembly coupled to the fan assembly. The core assembly may include a compressor section including at least one compressor having a plurality of compressor blades, a turbine section including at least one turbine having a plurality of turbine blades, a combustor section disposed between the compressor section and the turbine section, and a core case surrounding the compressor section, the turbine section, and the combustor section. The core case may define a containment section surrounding at least one of the compressor section and the turbine section, the containment section including a first containment layer including a first stack of containment plates having at least first and second containment plates spaced apart by a first set of standoffs, and a second containment layer including a second stack of containment plates having at least first and second containment plates spaced by a second set of standoffs. The containment section has a non-linear rate of energy dissipation across the first and second containment layers.

### BRIEF DESCRIPTION OF THE DRAWINGS

FIG. 1 is a schematic side elevation view, in partial cross-section, of an exemplary gas turbine engine;

FIG. 2 is an enlarged side elevation view, in cross-section, of a portion of the exemplary gas turbine engine of FIG. 1;

FIGS. 3A and 3B are schematic side elevation views, in cross-section, of exemplary embodiments of containment sections for the core of the gas turbine engine of FIGS. 1 and 2 having containment layers with a containment gap formed therebetween;

FIG. 4 is a schematic side elevation view, in cross-section, of an exemplary embodiment of a containment section for the core of the gas turbine engine of FIGS. 1 and 2 having bumpers to space containment layers;

FIGS. 5A and 5B are perspective views of exemplary embodiments of containment layers for the core of the gas turbine engine of FIGS. 1 and 2 having discontinuous surfaces forming recesses;

FIG. 6 is a perspective view of an exemplary embodiment of a containment section for the core of the gas turbine engine of FIGS. 1 and 2 having stacks of containment plates;

FIGS. 7A and 7B are schematic side elevation views, in cross-section, of exemplary embodiments of containment sections for the core of the gas turbine engine of FIGS. 1 and 2 having containment layers with substantially no gap formed therebetween; and

FIG. 8 is a side elevation view, in cross-section, of an exemplary embodiment of a containment section for the core of the gas turbine engine of FIGS. 1 and 2 having three containment layers and two containment gaps.

### DETAILED DESCRIPTION

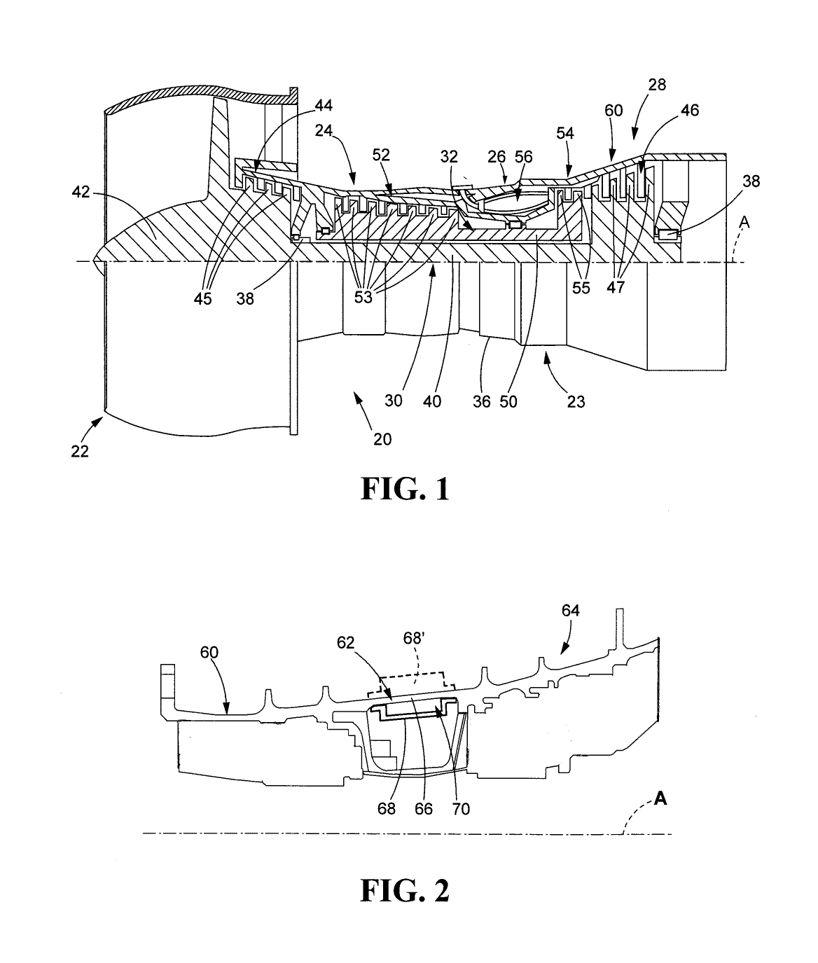

FIG. 1 schematically illustrates an exemplary gas turbine engine 20. The gas turbine engine 20 is disclosed herein as a two-spool turbofan that generally incorporates a fan section 22, and a core assembly 23. The core assembly 23 includes a compressor section 24, a combustor section 26, and a turbine section 28. Alternative engines might include an augmentor section (not shown) or a three spool architecture among other systems or features. The fan section 22 drives air along a bypass flowpath while the compressor section 24 drives air along a core flowpath for compression, communication into the combustor section 26, and expansion through the turbine section 28. Although depicted as a turbofan gas turbine engine in the exemplary, non-limiting embodiment, it should be understood that the concepts described herein are not limited to use with turbofans as the teachings may be applied to other types of turbine engines.

The engine 20 generally includes a low spool 30 and a high spool 32 mounted for rotation about an engine longitudinal axis A relative to an engine static structure 36 via several bearing systems 38. It should be understood that various bearing systems 38 at various locations may alternatively or additionally be provided.

The low spool 30 generally includes an inner shaft 40 that interconnects a fan 42, a low pressure compressor 44, and a low pressure turbine 46. The low pressure compressor 44 includes a plurality of low pressure compressor blades 45, while the low pressure turbine 46 includes a plurality of low pressure turbine blades 47. The low pressure compressor and turbine blades 45, 47 are coupled to and rotate with the inner shaft 40. The inner shaft 40 is further connected to the fan 42 through a geared architecture (not shown) to drive the fan 42 at a lower speed than the low spool 30.

The high spool 32 includes an outer shaft 50 that interconnects a high pressure compressor 52 and high pressure turbine 54. The high pressure compressor 52 includes a plurality of high pressure compressor blades 53, while the high pressure turbine 54 includes a plurality of high pressure turbine blades 55. The high pressure compressor and turbine blades 53, 55 are coupled to and rotate with the outer shaft 50. A combustor 56 is disposed between the high pressure compressor 52 and the high pressure turbine 54. The inner shaft 40 and the outer shaft 50 are concentric and rotate about the engine longitudinal axis A which is collinear with their longitudinal axes.

The core assembly 23 defines a main fluid path, commonly referred to as the core flowpath (not shown), through the engine. Air traveling into the core flowpath is compressed by the low pressure compressor 44 then the high pressure compressor 52, mixed and burned with fuel in the combustor 56, then expanded over the high pressure turbine 54 and low pressure turbine 46. The turbines 54, 46 rotationally drive the respective low spool 30 and high spool 32 in response to the expansion. As used herein, the low pressure compressor 44 and the high pressure compressor 52 may collectively be referred to as “compressors.” Similarly, the low pressure turbine 46 and the high pressure turbine 54 may collectively be referred to as “turbines.”

The core assembly 23 further includes a core case 60 that extends rearward from the fan section 22 along the engine axis A and generally surrounds the compressor section 24, the combustor section 26, and the turbine section 28. The core case 60 may include a containment section 62 surrounding at least one of the compressor section 24 and the turbine section 28 and configured to retain compressor and/or turbine blades (or fragments thereof) that may become liberated from their respective shafts. FIG. 2 illustrates the containment section 62 adjacent a high pressure turbine section 64 of the core assembly 23, where the core case 60 surrounds the high pressure turbine 54 (not shown in FIG. 2). The containment section 62, however, may be provided in other locations on the core assembly 23 to contain blade or blade fragments, such as around the low pressure compressor 44, the high pressure compressor 52, the low pressure turbine 46, or other areas where compressor or turbine blades may be used. While the containment section 62 is described herein primarily in conjunction with its ability to contain liberated blades or blade fragments, it will be appreciated that the containment section 62 may also serve other functions in the engine, such as a vane support or a seal support.

The containment section 62 includes a first containment layer 66 and a second containment layer 68 that are configured such that the containment section 62 has a non-linear rate of energy dissipation across the first and second containment layers 66, 68. The first and second containment layers 66, 68 may be provided in different configurations. For example, as shown in solid lines in FIG. 2, the first containment layer 66 may be disposed outwardly of the second containment layer 68 with a containment gap 70 formed therebetween. While the gap 70 is described herein primarily in conjunction with its ability to help improve blade containment, it will be appreciated that the gap 70 may also serve other functions in the engine, such as a passage for cooling air, control air, or instrumentation. The gap 70 may be sized primarily to serve one or more of these other functions, with containment being a secondary or auxiliary function provided by the gap. In an alternative configuration shown in phantom lines in FIG. 2, the first containment layer 66 may be disposed inwardly of the second containment layer 68′. In this alternative embodiment, it is also noted that substantially no gap is formed between the first and second containment layers 66, 68′. The first and second containment layers may form part of the case 60, may be non-case structures, or may be a combination of both case and non-case structures.

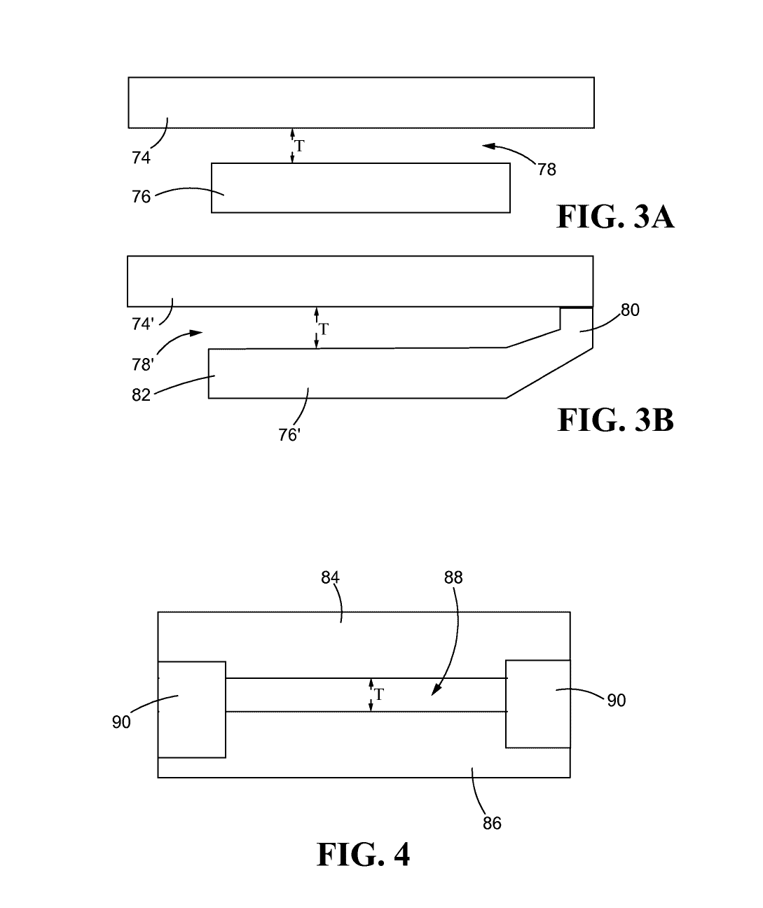

FIGS. 3A and 3B illustrate in greater detail embodiments in which a gap between containment layers is provided to create a non-linear rate of energy dissipation across the containment section. FIG. 3A illustrates an embodiment of a containment section having a first containment layer 74 spaced from a second containment layer 76 by a containment gap 78. In this embodiment, there is no direct coupling between the first and second containment layers 74, 76. Instead, the first and second containment layers 74, 76 are supported independent from one another by other components of the engine 20. FIG. 3B illustrates a containment section having a first containment layer 74′ spaced from a second containment layer 76′ by a containment gap 78′, but there is a limited area of direct coupling between the first and second containment layers 74′, 76′. Specifically, the second containment layer 76′ has a fixed end 80 coupled to the first containment layer 74′ and a free end 82 spaced from the first containment layer 74′, so that the second containment layer 76′ is supported from the first containment layer 74′ in cantilever fashion. In the embodiments illustrated in FIGS. 3A and 3B, each of the containment gaps 78, 78′ has a gap thickness “T” sized sufficiently to permit the layers to independently deform or otherwise dissipate energy at different rates, or to permit unique interplay between the layers, thereby to produce a non-linear rate of energy dissipation across the containment section.

FIG. 4 illustrates another embodiment of a containment section in which a gap is formed between containment layers. As shown in FIG. 4, a first containment layer 84 is spaced from a second containment layer 86 by a containment gap 88. A plurality of bumpers 90 is disposed between the first containment layer 84 and the second containment layer 86 to maintain a gap thickness “T” of the containment gap 88. Again, the gap thickness “T” is sized sufficiently to produce a non-linear rate of energy dissipation across the containment section.

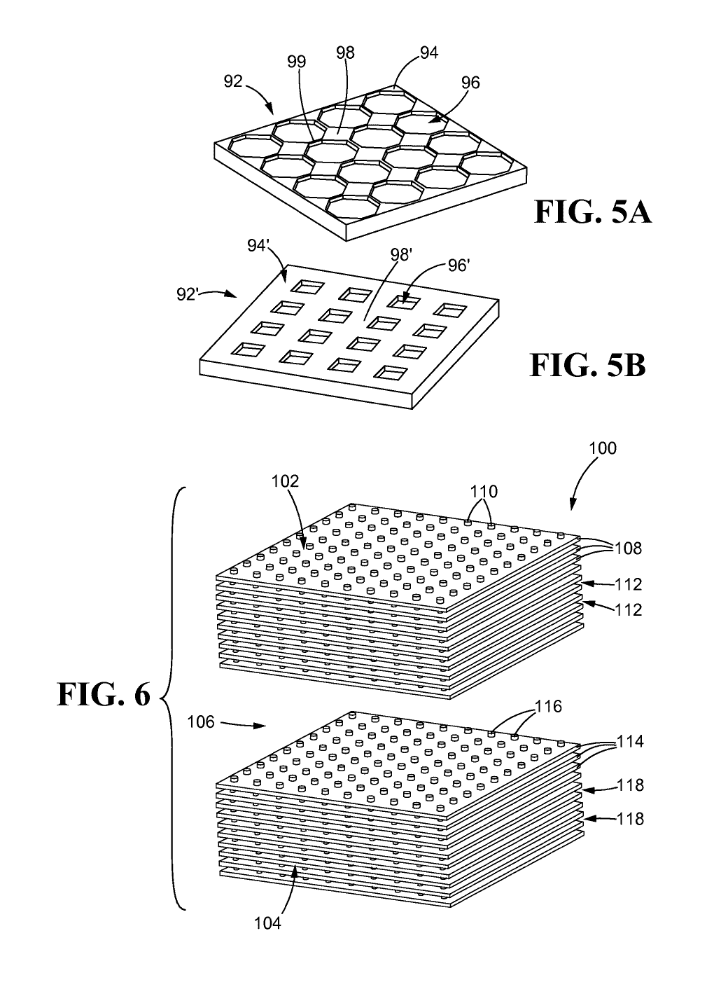

FIGS. 5A and 5B illustrate further alternative embodiments in which a discontinuous gap is formed between containment layers. FIG. 5A illustrates a containment layer 92, which may be provided as either or both of the first and second containment layers in a containment section, that includes a discontinuous surface 94 defining an array of recesses 96. The recesses 96 may be formed in a repeating, isogrid pattern extending across the entire discontinuous surface 94. In FIG. 5A, the discontinuous surface 94 includes a plurality of square-shaped lands 98 connected by walls 99 to define octagonal-shaped recesses 96. In an alternative embodiment illustrated in FIG. 5B, a containment layer 92′ has a discontinuous surface 94′ with recesses 96′. In this embodiment, the discontinuous surface 94′ includes a grid-shaped land 98′ defining square-shaped recesses 96′. In these embodiments, the discontinuous surfaces alter the structural properties of the associated containment layer, thereby varying the rate at which energy from impacts is dissipated within the layer. Accordingly, when containment layers having different structural properties are used, the containment section will have a non-linear rate of energy dissipation across its thickness, thereby to improve containment of liberated blades or blade fragments.

FIG. 6 illustrates yet another embodiment of a containment section 100 that uses multiple gaps to produce a non-linear rate of energy dissipation. More specifically, the containment section 100 includes first and second containment layers 102, 104 separated by a containment gap 106. The first containment layer 102 includes a stack of first containment plates 108. Adjacent pairs of first containment plates 108 are spaced from each other by a plurality of first standoffs 110 to define first plate gaps 112 therebetween. The first standoffs 110 provided in adjacent first plate gaps 112 may be aligned with or offset from one another. Similarly, the second containment layer 104 includes a stack of second containment plates 114, with adjacent pairs of second containment plates 114 spaced from each other by a plurality of second standoffs 116 to define second plate gaps 118 therebetween. The second standoffs 116 provided in adjacent second plate gaps 118 may be aligned with or offset from one another. In this embodiment, therefore, a plurality of gaps, including first plate gaps 112, second plate gaps 118, and the containment gap 106, are provided to produce a non-linear rate of energy dissipation across the containment section 100.

While the embodiment illustrated at FIG. 6 shows both of the first and second containment layers 102, 104 as discrete stacks of containment plates 108, 114, it will be appreciated that only one of the first and second containment layers 102, 104 may be formed as a stack of containment plates. Still further, the containment gap 106 may be eliminated so that the first and second containment layers 102, 104 are disposed directly adjacent one another, in which case the first and second containment layers 102, 104 will effectively form a single aggregated stack of containment plates 108, 114.

The standoffs 110, 116 help maintain desired thicknesses for the first and second plate gaps 112, 118, respectively. It is noted that FIG. 6 illustrates a small segment of the containment section 100, and that the first and second containment plates 108, 114, the first and second plate gaps 112, 118, and the containment gap 106 may have substantially annular shapes concentrically arranged around the engine longitudinal axis A. The standoffs 110, 116, therefore may have a first configuration in which the standoffs of the multiple containment plates are radially aligned relative to the engine longitudinal axis A. In an alternative configuration, the standoffs 110, 116 may be radially offset relative to the engine longitudinal axis A.

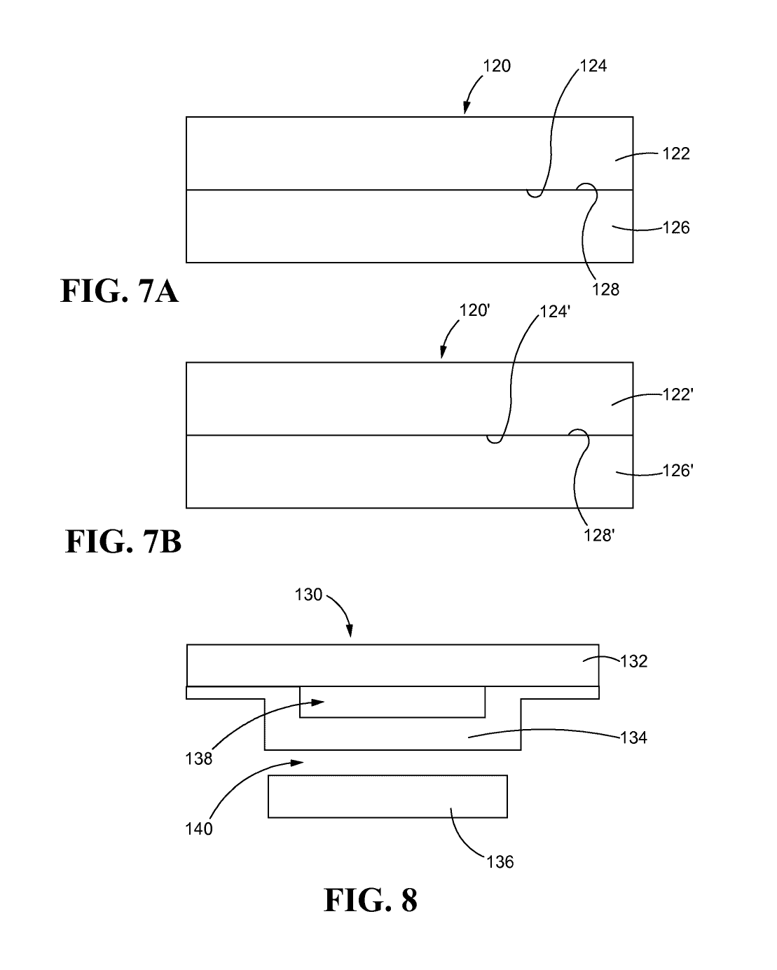

In the foregoing embodiments, containment sections are described that provide gaps between the containment layers to create variations in structural properties, thereby to achieve a non-linear rate of energy dissipation across the thickness of the containment layers. In FIGS. 7A and 7B, further alternative embodiments of containment sections are shown that use differences in material properties to achieve the non-linear rate of energy dissipation. More specifically, FIGS. 7A and 7B illustrate containment sections 120, 120′ having first or outer containment layers 122, 122′ defining inner surfaces 124, 124′ and second or inner containment layers 126, 126′ defining outer surfaces 128, 128′. The inner surfaces 124, 124′ closely overlay, are coupled to, or are otherwise in intimate contact with the respective outer surface 128, 128′ so that substantially no gaps are formed between the first and second containment layers. The first containment layers 122, 122′ are formed of first containment layer materials, while the second containment layer 126, 126′ are formed of second containment layer materials that are different from the first containment layer materials. In the embodiment shown in FIG. 7A, the first material is a relatively hard material, such as Inconel 718, while the second material is a relatively soft material, such as Inconel 625. Thus, in this embodiment, the softer second containment layer 126 is disposed nearer the longitudinal engine axis A than the harder first containment layer 122. Alternatively, in the embodiment shown in FIG. 7B, the first material is a relatively soft material while the second material is a relatively hard material, so that the harder second containment layer 126′ is disposed nearer the longitudinal engine axis A than the softer first containment layer 122′. In both embodiments, materials having different material hardness are used for the first and second containment layers, thereby to create a non-linear rate of energy dissipation across the containment section 120.

FIG. 8 illustrates a further embodiment of a containment section 130 having an additional containment layer. More specifically, the containment section 130 includes a first containment layer 132, a second containment layer 134, and a third containment layer 136. In the illustrated embodiment, a first containment gap 138 is formed between the first and second containment layers 132, 134 and a second containment gap 140 is formed between the second and third containment layers 134, 136. It will be appreciated, however, that the first and second containment gaps 138, 140 may be eliminated. Additionally, while the second containment layer 134 is shown directly coupled to the first containment layer 132 and the third containment layer 136 is shown as being supported independently of the first and second containment layers 132, 134, other configurations may be used. Each of the first, second, and third containment layers 132, 134, 136 may be formed according to any of the embodiments described above to produce containment layers having different material, structural, or other properties, thereby to obtain an non-linear rate of energy dissipation across the thickness of the containment section 130.

### INDUSTRIAL APPLICABILITY

In operation, the containment section improves containment of liberated blades and blade fragments within the core assembly 23. The containment section may include at least a first containment layer having a first containment layer property and a second containment layer having a second containment layer property different from the first containment layer property. The first and second containment layer properties may relate to mechanical, structural, material, or other physical properties that influence the rate of energy dissipation within the associated containment layer. For example, the containment layer properties may be relative structural strengths, such as the formation of a containment gap between layers or recess formed in at least one of the layers. Alternatively, the containment layer properties may relate to material hardness. In any case, the containment layer property is varied between the first and the second containment layers so that energy dissipation is non-linear through the thickness of the containment section. Additionally or alternatively, the use of a gap between the containment layers structurally decouples the layers, allowing them to act independently of each other during a containment event. Thus, in embodiments where a gap is provided, the containment layers may be formed of the same material. Accordingly, in each of the foregoing embodiments, blade and blade fragment containment is improved when compared to a monolithic structure occupying the same volume and space as the multi-layer assemblies disclosed herein.

What is claimed is:

1. A gas turbine engine disposed along a longitudinal engine axis, the gas turbine engine comprising:
a fan assembly; and
a core assembly coupled to the fan assembly, the core assembly including:
a compressor section;
a turbine section; and
a core case surrounding the compressor section and the turbine section, the core case defining a containment section surrounding at least one of the compressor section and the turbine section, the containment section including a first containment layer and a second containment layer, the containment section being configured to have a non-linear rate of energy dissipation across the first and second containment layers.

2. The gas turbine engine of claim 1, in which the first containment layer is spaced from the second containment layer to define a containment gap having a gap thickness sized sufficiently to produce a non-linear rate of energy dissipation across the first and second containment layers.

3. The gas turbine engine of claim 2, in which the first containment layer is directly coupled to the second containment layer.

4. The gas turbine engine of claim 3, in which the second containment layer includes a fixed end coupled to the first containment layer and a second end spaced from the first containment layer.

5. The gas turbine engine of claim 2, in which the first containment layer is supported independent of the second containment layer.

6. The gas turbine engine of claim 2, further comprising a plurality of bumpers disposed between the first containment layer and the second containment layer to maintain the gap thickness of the containment gap.

7. The gas turbine engine of claim 1, in which at least one of the first and second containment layers comprises a stack of containment plates including at least first and second containment plates spaced apart by a first set of standoffs.

8. The gas turbine engine of claim 7, in which the stack of containment plates includes a third containment plate spaced from the second containment plate by a second set of standoffs, wherein each standoff in the first set of standoffs is radially offset from each standoff in the second set of standoffs.

9. The gas turbine engine of claim 1, in which both of the first and second containment layers includes a stack of containment plates, each stack of containment plates including at least first and second containment plates spaced apart by a set of standoffs.

10. The gas turbine engine of claim 1, in which the first containment layer comprises a first material and the second containment layer comprises a second material different from the first material.

11. The gas turbine engine of claim 10, in which the first material comprises a relatively hard material and the second material comprises a relatively soft material.

12. The gas turbine engine of claim 11, in which the first containment layer is disposed nearer the longitudinal engine axis than the second containment layer.

13. The gas turbine engine of claim 1, in which at least one of the first and second containment layers includes a discontinuous surface defining an array of recesses.

14. The gas turbine engine of claim 13, in which both the first and second containment layers includes a discontinuous surface defining an array of recesses.

15. The gas turbine engine of claim 1, in which the containment section further comprises a third containment layer.

16. A core assembly comprising:
a compressor section;
a turbine section; and
a core case surrounding the compressor section and the turbine section, the core case defining a containment section surrounding at least one of the compressor section and the turbine section, the containment section including a first containment layer defining a first surface and a second containment layer defining a second surface directly coupled to the first surface, the first containment layer being configured with a first containment layer property and the second containment layer being configured with a second containment layer property different from the first containment layer property so that the containment section has a non-linear rate of energy dissipation across the first and second containment layers.

17. The core assembly of claim 16, in which:
the first containment layer comprises a first containment layer material and the first containment layer property comprises a first containment layer material hardness;
the second containment layer comprises a second containment layer material and the second containment layer property comprises a second containment layer material hardness; and
the first containment layer material hardness is different than the second containment layer material hardness.

18. The core assembly of claim 16, in which:
the first containment layer comprises a discontinuous surface defining an array of recesses and the first containment layer property comprises a first containment layer structural strength; and
the second containment layer property comprises a second containment layer structural strength different than the first containment layer structural strength.

19. A gas turbine engine disposed along a longitudinal engine axis, the gas turbine engine comprising:
a fan assembly; and
a core assembly coupled to the fan assembly, the core assembly including:
a compressor section including at least one compressor having a plurality of compressor blades;
a turbine section including at least one turbine having a plurality of turbine blades;
a combustor section disposed between the compressor section and the turbine section; and
a core case surrounding the compressor section, the turbine section, and the combustor section, the core case defining a containment section surrounding at least one of the compressor section and the turbine section, the containment section including:
a first containment layer including a first stack of containment plates having at least first and second containment plates spaced apart by a first set of standoffs; and
a second containment layer including a second stack of containment plates having at least first and second containment plates spaced by a second set of standoffs;
wherein the containment section has a non-linear rate of energy dissipation across the first and second containment layers.

20. The gas turbine engine of claim 19, in which the first containment layer is spaced from the second containment layer by a containment gap.
